(19) United States
(12) Patent Application Publication
(10) Pub. No.: US 2018/0338518 A1
(43) Pub. Date: Nov. 29, 2018

(54) DIETARY INTERVENTION WITH REDUCED DAILY CALORIC INTAKE

(71) Applicant: Beachbody, LLC, El Segundo, CA (US)

(72) Inventors: Isabelle Daikeler, Malibu, CA (US); Michael Wilson, Rossmoor, CA (US); May Lam, Torrance, CA (US); Nima Alamdari, Los Angeles, CA (US)

(73) Assignee: Beachbody, LLC, El Segundo, CA (US)

(21) Appl. No.: 15/968,155

(22) Filed: May 1, 2018

Related U.S. Application Data
(62) Division of application No. 14/292,494, filed on May 30, 2014, now abandoned.

(51) Int. Cl. A23L 33/00

(52) U.S. Cl. CPC A23L 33/40; A23V 2002/00

(57) ABSTRACT

The invention relates to various compositions for controlling body weight and/or for promoting weight loss. Examples of these compositions include but are not limited to Formula I, Formula I-vegan, Formula II, and Formula III. The invention also relates to methods of using these compositions and kits including these compositions to control body weight and/or promote weight loss.

### FIELD OF THE INVENTION

The invention relates to compositions, methods and kits for controlling body weight and/or for promoting weight loss.

### BACKGROUND

All publications cited herein are incorporated by reference in their entirety to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

This invention demonstrates that a unique three-day dietary intervention significantly reduces daily caloric intake to ˜900 kcals/day, while maintaining satiation and meeting critical nutritional requirements beyond calories to maintain lean muscle while burning fat. Achieving weight loss through caloric restriction is known; however, achieving significant calorie reduction without feeling hungry through this specialized diet program is novel. In addition, the combination of high protein drinks with high fiber plus high volume foods that are harder for the body to digest delivers a combination to maintain both satiation and metabolic rate.

For controlling body weight and/or for promoting weight loss, the invention provides compositions, methods and kits comprising dietary intervention with reduced daily caloric intake.

### SUMMARY OF THE INVENTION

Various embodiments of the present invention provide a composition (Formula I). Formula I may consist of or may comprise or may consist essentially of one or more of: Whey Protein; Cocoa Powder; Pea Protein; Fructose; Natural Flavors; Vitamin and Mineral Premix; Maca Root Powder; Flaxseed; Chia; Pea Fiber; Xanthan Gum; Quinoa Powder; Yacon Root Powder; Inulin; Chlorella Powder; Spirulina; Acerola Berry Powder; Camu Camu Extract; Pomegranate Juice Powder; Sacha Inchi Powder; Astragalus Root Powder; Bilberry Fruit Powder; Blueberry Fruit Powder; Lycium/Goji Berry Powder; Spinach Powder; Acai Powder; Methylsulfonylmethane; Natural Sweeteners; Ashwagandha Root Powder; Cordyceps Powder; Enzyme Blend; Kale; Maitake Powder; Reshi Mushroom Powder; Amaranth Flour Powder; Salt, Himalayan Pink; Probiotic; Citrus Bioflavonoids; Grape Seed Extract; Green Tea Leaf Powder; Holy Basil Powder; Rose Hips Powder; Schisandra Berry Powder; Cinnamon Powder; Ginko Biloba Leaf Powder; Moringa Leaf Powder; and Mixed Tocopherols.

Various embodiments of the present invention provide a composition (Formula I-vegan). Formula I-vegan may consist of or may comprise or may consist essentially of one or more of: Pea Protein; Cocoa Powder; Agave Powder; Oat Protein; Rice Protein; Defatted Chia Powder; Yacon Root Powder; Maca Root Powder; Flaxseed; Xanthan Gum; Acerola Powder; Spirulina; Chlorella; Camu-Camu Powder; Pomegranate Powder; Astragalus Root Powder; Bilberry Fruit Powder; Blueberry Fruit Powder; Lycium/Goji Berry Powder; Salt, Himalayan Pink; Moringa Leaf Powder; Pea Fiber; Quinoa Powder; Acai Powder; Methylsulfonylmethane; Spinach Powder; Natural Sweeteners; Ashwagandha Root Powder; Cordyceps Powder; Enzyme Blend; Maitake Powder; Reshi Mushroom Powder; Probiotic; Kale Leaves Powder; Citrus Bioflavonoids; Green Tea Leaf Powder; Holy Basil Powder; Rose Hips Powder; Schisandra Berry Powder; Amaranth Powder; Cinnamon Powder; and Ginko Biloba Leaf Powder.

Various embodiments of the present invention provide a composition (Formula II). Formula II may consist of or may comprise or may consist essentially of one or more of: Oat Protein; Pea Protein; Agave Powder; Nutriose FM 06; Medium Chain Triglyceride oil; Vitamin/mineral premix; Natural Flavors; Xanthan gum; Probiotic; Natural Sweeteners; and Potato protein Extract.

Various embodiments of the present invention provide a composition (Formula III). Formula III may consist of or may comprise or may consist essentially of one or more of: Psylium Husk; Flaxseed; Chia seed; Natural Flavors; Citric Acid; and Natural Sweeteners.

Various embodiments of the present invention provide a method for controlling body weight and/or for promoting weight loss in a subject. The method may consist of or may comprise or may consist essentially of: providing any one or more of Formula I or I-vegan, Formula II, and Formula III; and administering an effective amount of the one or more of Formula I or I-vegan, Formula II, and Formula III to the subject, thereby controlling body weight and/or promoting weight loss in the subject.

Various embodiments of the present invention provide a kit for controlling body weight and/or for promoting weight loss in a subject. The kit may consist of or may comprise or may consist essentially of: any one or more of Formula I or I-vegan, Formula II, and Formula III; and instructions for using the one or more of Formula I or I-vegan, Formula II, and Formula III to control body weight and/or promote weight loss in the subject.

### BRIEF DESCRIPTION OF THE DRAWINGS

Exemplary embodiments are illustrated in referenced figures. It is intended that the embodiments and figures disclosed herein are to be considered illustrative rather than restrictive.

FIG. 1 depicts, in accordance with various embodiments of the invention, the results of Test group 1. (A) Body weight, (B) waist circumference, and (C) hip circumference change in the 3 Day Refresh group during the study period. Mean±S.E., *P<0.05.

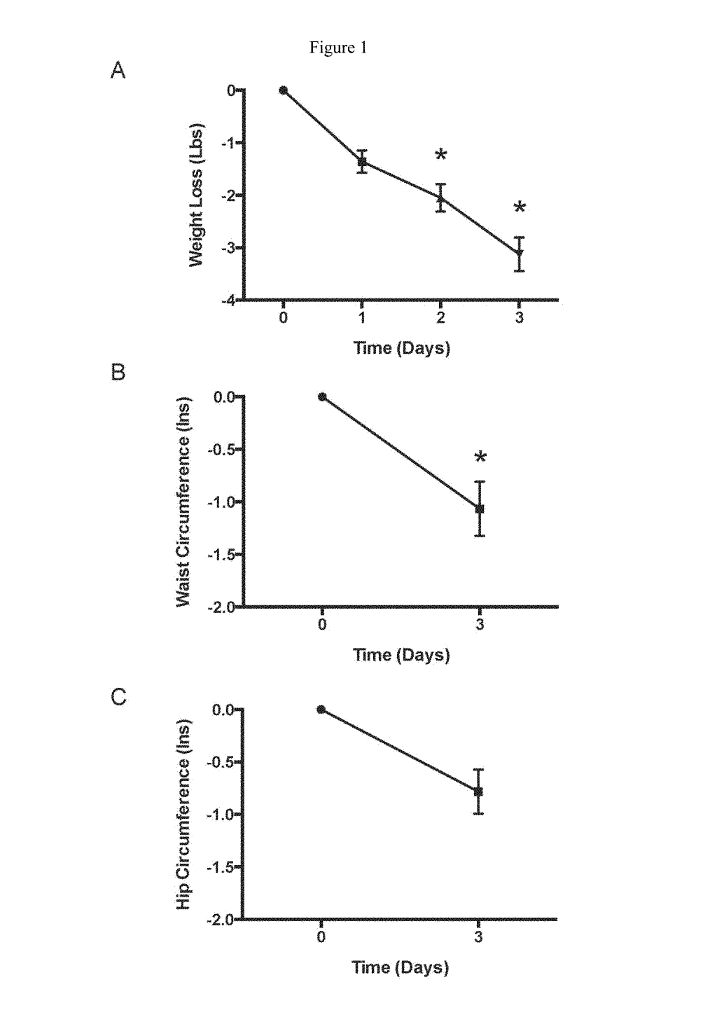

FIG. 2 depicts, in accordance with various embodiments of the invention, the results of Test group 2. (A) Body weight, (B) waist circumference, and (C) hip circumference change in the 3 Day Refresh group during the study period. Mean±S.E., *P<0.05.

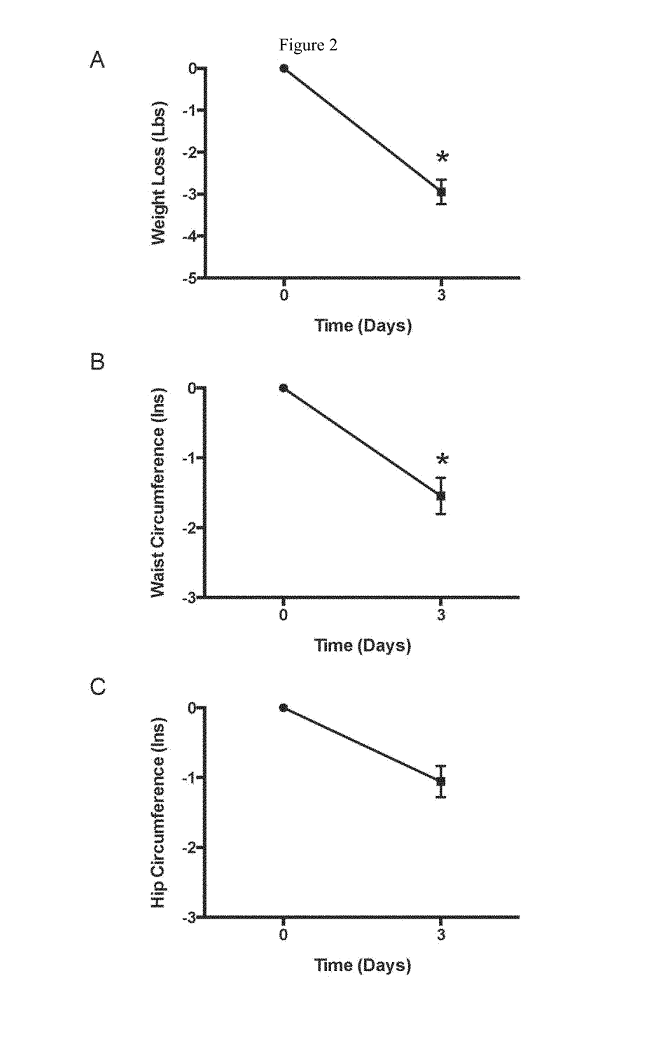

FIG. 3 depicts, in accordance with various embodiments of the invention, the results of Test group 3. (A) Body weight, (B) waist circumference, and (C) hip circumference change in the 3 Day Refresh group during the study period. Mean±S.E., *P<0.05.

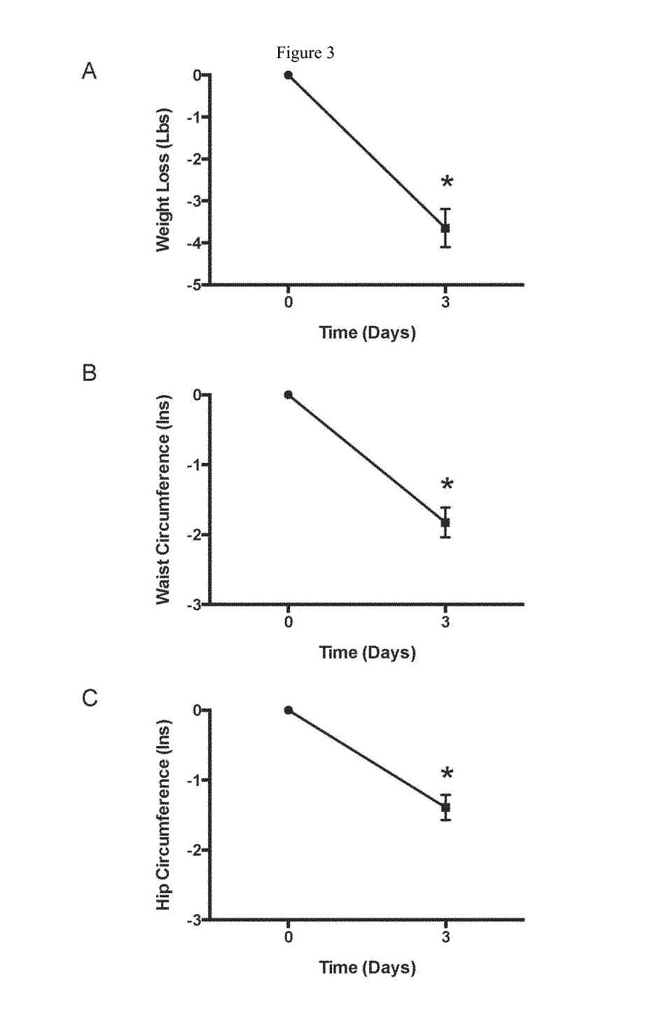

FIG. 4 depicts, in accordance with various embodiments of the invention, the appetite results of a test group of 24 participants. In each group of five data bars, from left to right: starving, hungry, OK, full, and challenged to finish food provided.

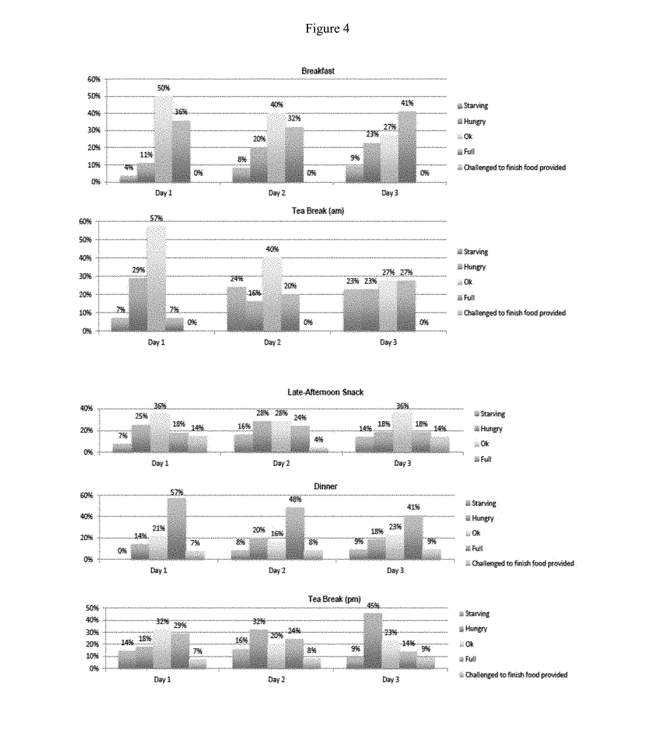

### DETAILED DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs. Allen et al., Remington: The Science and Practice of Pharmacy 22^{nd} ed., Pharmaceutical Press (Sep. 15, 2012); Hornyak et al., Introduction to Nanoscience and Nanotechnology, CRC Press (2008); Singleton and Sainsbury, Dictionary of Microbiology and Molecular Biology 3^{rd} ed., revised ed., J. Wiley & Sons (New York, N.Y. 2006); Smith, March's Advanced Organic Chemistry Reactions, Mechanisms and Structure 7^{th} ed., J. Wiley & Sons (New York, N.Y. 2013); Singleton, Dictionary of DNA and Genome Technology 3^{rd} ed., Wiley-Blackwell (Nov. 28, 2012); and Green and Sambrook, Molecular Cloning: A Laboratory Manual 4th ed., Cold Spring Harbor Laboratory Press (Cold Spring Harbor, N.Y. 2012), provide one skilled in the art with a general guide to many of the terms used in the present application. For references on how to prepare antibodies, see Greenfield, Antibodies A Laboratory Manual 2^{nd} ed., Cold Spring Harbor Press (Cold Spring Harbor N.Y., 2013); Köhler and Milstein, Derivation of specific antibody-producing tissue culture and tumor lines by cell fusion, Eur. J. Immunol. 1976 July, 6(7):511-9; Queen and Selick, Humanized immunoglobulins, U.S. Pat. No. 5,585,089 (1996 December); and Riechmann et al., Reshaping human antibodies for therapy, Nature 1988 Mar. 24, 332(6162):323-7.

One skilled in the art will recognize many methods and materials similar or equivalent to those described herein, which could be used in the practice of the present invention. Other features and advantages of the invention will become apparent from the following detailed description, taken in conjunction with the accompanying drawings, which illustrate, by way of example, various features of embodiments of the invention. Indeed, the present invention is in no way limited to the methods and materials described. For convenience, certain terms employed herein, in the specification, examples and appended claims are collected here.

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments, and are not intended to limit the claimed invention, because the scope of the invention is limited only by the claims. Unless otherwise defined, all technical and scientific terms used herein have the same meaning as commonly understood by one of ordinary skill in the art to which this invention belongs.

As used herein the term “comprising” or “comprises” is used in reference to compositions, methods, and respective component(s) thereof, that are useful to an embodiment, yet open to the inclusion of unspecified elements, whether useful or not. It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.).

Unless stated otherwise, the terms “a” and “an” and “the” and similar references used in the context of describing a particular embodiment of the application (especially in the context of claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. The abbreviation, “e.g.” is derived from the Latin exempli gratia, and is used herein to indicate a non-limiting example. Thus, the abbreviation “e.g.” is synonymous with the term “for example.” No language in the specification should be construed as indicating any non-claimed element essential to the practice of the application.

As used herein, a “subject” means a human or animal. The terms “individual” and “subject” are used interchangeably herein. In an embodiment, the subject is a mammal, and in another embodiment, is human.

The term “statistically significant” or “significantly” refers to statistical evidence that there is a difference. It is defined as the probability of making a decision to reject the null hypothesis when the null hypothesis is actually true. The decision is often made using the p-value.

As used herein, the term “administering” refers to the placement of a composition as disclosed herein into a subject by a method or route which results in at least partial localization of the composition at a desired site. “Route of administration” may refer to any administration pathway known in the art, including but not limited to aerosol, nasal, oral, transmucosal, transdermal, parenteral, enteral, topical or local. Via the enteral route, the compositions can be in the form of tablets, gel capsules, sugar-coated tablets, syrups, suspensions, solutions, powders, granules, emulsions, microspheres or nanospheres or lipid vesicles or polymer vesicles allowing controlled release. In an embodiment, the compositions are provided in a powder form and mixed with a liquid, such as water, to form a beverage. In accordance with the present invention, “administering” can be self-administering. For example, it is considered as “administering” that a subject consumes a composition as disclosed herein.

Unless otherwise defined herein, scientific and technical terms used in connection with the present application shall have the meanings that are commonly understood by those of ordinary skill in the art to which this disclosure belongs. It should be understood that this invention is not limited to the particular methodology, protocols, and reagents, etc., described herein and as such can vary. The terminology used herein is for the purpose of describing particular embodiments only, and is not intended to limit the scope of the present invention, which is defined solely by the claims.

The present invention provides various compositions (i.e., the formulas described herein) for controlling body weight and/or for promoting weight loss. The compositions may include one or more types of ingredients, including but not limited to adaptogens, superfoods, probiotics, enzymes, plant products, algae, vitamins, minerals, protein sources, sulfur sources, and other nutrients. In various embodiments, the compositions are used as a complete meal replacement.

As used herein, “adaptogens” refer to agents which raise the subject's nonspecific resistance to various physical, chemical or biological stressors. Adaptogens generally accomplish this by either regulating the activity of hyperfunctioning systems. Examples of adaptogens include but are not limited to Astragalus root, Cordyceps, Maca root, Schisandra berry, Ashwagandha root, Holy basil leaf, Reishi mushroom, Maitake mushroom, Suma root. Other adaptogens which are both non-toxic to the subject and are capable of raising the subject's nonspecific resistance to external stressors may be used as well. The compositions described herein may include one or more adaptogens. The adaptogens may be provided in powdered form. The adaptogens may be provided as a blend or mixture.

As used herein, “superfoods” refer to foods which have nutritional significance due to their nutrient richness and high antioxidant capacity. Examples of superfoods include but are not limited to Acerola, Bioflavonoids, Acai berry, Goji berries (Lyceum barbarium), Blueberry, Ginkgo biloba leaf, Camu camu, Pomegranate, Rose hips, Bilberry, Maitake mushroom, and Citrus bioflavonoids. Other superfoods having high antioxidant capacity, for non-limiting examples, elderberry, cranberry, guarana, mango, noni, sea-buckthorn, and grapes may be used as well. The compositions described herein may include one or more superfoods. The superfoods may be provided in powdered form. The superfoods may be provided as a blend or mixture.

Enzymes increase the bioavailability of antioxidants contained in the superfoods and thus increase the antioxidant efficacy in the body in the most usable form. Examples of enzymes include but are not limited to Amylase, Lipase, Cellulase, Bromelain, Protease, Lactase, and Papain. Other digestive enzymes which do not interfere with the antioxidant capacity of the superfoods may be used as well. The compositions described herein may include one or more enzymes. The enzymes may be provided in powdered form. The enzymes may be provided as a blend or mixture.

As used herein, “probiotics” refer to bacterial cultures which are intended to assist the subject's naturally occurring gut flora, an ecology of microbes, to reestablish themselves.

Probiotics aid in digestion and help with the body's absorption of nutrients, including antioxidants. Examples of probiotics include but are not limited to Lactobacillus acidophilus, Lactobacillus bulgaricus, Streptococcus thermophiles, Lactobacillus acidophilus DDS-1, Lactobacillus casei, and Bifidobacterium longum. Other probiotics which are known to benefit the subject's gut flora and enhance in the digestion and absorption of nutrients may be used as well. The compositions described herein may include one or more probiotics. The probiotics may be provided in powdered form. The probiotics may be provided as a blend or mixture.

Examples of plant products include but are not limited to Barley grass, Kamut grass, Hydrilla, Spinach, Whole flax seed meal, Chia seed, Grape seed extract, Pea fiber, Wheat grass, Oat grass, Sprouted amaranth, Sprouted quinoa, Green tea extract, Yacon root, Sacha inchi, and Apple fiber. Other plant products which provide beneficial phytochemicals and nutrients that the body needs may be used as well. The compositions described herein may include one or more plant products. The plant products may be provided in powdered form. The plant products may be provided as a blend or mixture.

Examples of algae include but are not limited to Blue green algae, Chlorella, and Spirulina. Other algae species which have similar beneficial effects as the ones listed here may be used as well. The compositions described herein may include one or more algae species. The algae may be provided in powdered form. The algae may be provided as a blend or mixture.

Example of vitamins and minerals include but are not limited to Vitamin A (as beta carotene and palmitate), Vitamin C (as ascorbic acid), Vitamin D (as cholecalciferol), Vitamin E (as d-alpha tocopheryl succinate), Vitamin K1 (as phytonadione), Vitamin B1 (as thiamin HCl and mononitrate), Calcium (as dicalcium phosphate), Phosphorus (as dicalcium phosphate), Magnesium (as oxide), Copper (as copper oxide and AA chelate), Chromium (as chromium amino acid chelate and picolinate), Vitamin B2 (as riboflavin), Vitamin B3 (as riacin), Vitamin B6 (as pyridoxine HCl), Vitamin B12, Biotin, Pantothenic acid (as d-calcium pantothenate), Iodine (as kelp and potassium iodine), Zinc (as zinc oxide and sulfate), Manganese (as manganese amino acid chelate), and Molybdenum (as sodium molybdenate). The compositions described herein may include one or more vitamins and minerals. The vitamins and minerals may be provided in powdered form. The vitamins and minerals may be provided as a blend or mixture.

One non-limiting example of the protein sources is whey protein (isolate). One non-limiting example of sulfur sources is Methylsulfonylmethane (MSM).

Various flavor ingredients may be added to enhance the flavor of the composition, such as fruit powders. In one embodiment, a fruity or berry flavor may be imparted on the composition by adding any one or a combination of banana, carrot, orange, pineapple, raspberry, and strawberry powders. In another embodiment, a chocolate flavor may be imparted by adding any one or a combination of chocolate, cocoa, and cinnamon powders. The relative concentration the flavor ingredients in the formulation may be altered based on the desired taste. It is understood that additional ingredients may be added as flavor ingredients, so long as they do not interfere with composition's effect of controlling body weight and/or for promoting weight loss.

### Compositions of the Invention

In various embodiments, the present invention provides a composition (Formula I) for controlling body weight and/or for promoting weight loss. Ingredients of Formula I may include but are not limited to Brown rice protein, Pea protein, Coconut flower nectar, Cacao, Konjac, Maca root (Lepidium meyenii), Yacon root (Smallanthus sonchifolius), Sacha inchi (Plukenetia volubilis, seed), Chia (Salvia hispanica, seed), Apple pectin (Malus pumila, fruit), MSM (Methylsulfonylmethane), Pomegranate (Punica granatum, fruit), Spirulina (Arthrospira platensis, Arthrospira maxima, whole), Chlorella (Chlorella spp., whole), Acerola cherry (Malpighia glabra, fruit), Astragalus root (Astragalus membranaceus), Bilberry (Vaccinium spp., fruit), Flax (Linum usitatissimum, seed), Goji berry (Lycium barbarum), Moringa (Moringa oleifera, leaf), Himalayan salt, Cinnamon powder, Quinoa (Chenopodium quinoa, seed), Camu-Camu (Myrciaria dubia, fruit), Agai (Euterpe oleraceae, fruit), Pea fiber (Pisum spp., seed), Blueberry (Vaccinium angustifolim, fruit), Cordyceps (Cordyceps sinensis, fungi), Enzyme blend (Protease, Amylase, Bromelain, Cellulase, Lipase, Papain, Lactase), Ashwagandha root (Withania somnifera), Maitake mushroom (Grifola frondosa), Lactobacillus sporogenes (as Bacillus coagulans), Luo Han Guo (Momordica grosvenori), Spinach (Spinacia oleracea, leaf), Reishi mushroom (Ganoderma lucidum), Tulsi (Holy basil, Ocimum sanctum, leaf), Citrus bioflavonoids, Green tea (Camellia sinensis, leaf), Rose hips (Rosa canina, fruit), Schisandra (Schisandra spp., fruit), Amaranth (Amaranthus hypochondriacus, seed), Barley grass juice (Hordeum vulgare), Kamut grass juice (Triticum turanicum), Oat grass juice (Avena sativa), Wheat grass juice (Triticum aestivum), Ginkgo (Ginkgo biloba, leaf), and Tapioca and Stevia (Stevia rebaudiana, leaf).

In various embodiments, all the ingredients of Formula I are dry blended together. In various embodiments, one serving of Formula I is packaged as one packet.

In various embodiments, Formula I may consist of or may comprise or may consist essentially of one or more of: Whey Protein; Cocoa Powder; Pea Protein; Fructose; Natural Flavors; Vitamin and Mineral Premix; Maca Root Powder; Flaxseed; Chia; Pea Fiber; Xanthan Gum; Quinoa Powder; Yacon Root Powder; Inulin; Chlorella Powder; Spirulina; Acerola Berry Powder; Camu Camu Extract; Pomegranate Juice Powder; Sacha Inchi Powder; Astragalus Root Powder; Bilberry Fruit Powder; Blueberry Fruit Powder; Lycium/Goji Berry Powder; Spinach Powder; Acai Powder; Methylsulfonylmethane; Natural Sweeteners; Ashwagandha Root Powder; Cordyceps Powder; Enzyme Blend; Kale; Maitake Powder; Reshi Mushroom Powder; Amaranth Flour Powder; Salt, Himalayan Pink; Probiotic; Citrus Bioflavonoids; Grape Seed Extract; Green Tea Leaf Powder; Holy Basil Powder; Rose Hips Powder; Schisandra Berry Powder; Cinnamon Powder; Ginko Biloba Leaf Powder; Moringa Leaf Powder; and Mixed Tocopherols.

In various embodiments, Formula I may consist of or may comprise or may consist essentially of one or more of: about 22-27%, 20-29%, 17-32%, or about 25% Whey Protein; about 17-21%, 15-23%, 12-26%, or about 19% Cocoa Powder; about 13-16%, 11-18%, 8-21%, or about 15% Pea Protein; about 11-14%, 9-16%, 6-19%, or about 12% Fructose; about 4.3-5.2%, 4.1-5.4%, 3.8-5.7%, or about 4.8% Natural Flavors; about 4.0-4.9%, 3.8-5.1%, 3.5-5.4%, or about 4.4% Vitamin and Mineral Premix; about 1.8-2.2%, 1.6-2.4%, 1.3-2.7%, or about 2.0% Maca Root Powder; about 1.3-1.5%, 1.2-1.6%, 0.9-1.9%, or about 1.4% Flaxseed; about 1.3-1.5%, 1.2-1.6%, 0.9-1.9%, or about 1.4% Chia; about 1.1-1.3%, 0.9-1.5%, 0.6-1.8%, or about 1.2% Pea Fiber; about 1.3-1.6%, 1.1-1.8%, 0.8-2.1%, or about 1.4% Xanthan Gum; about 1.1-1.4%, 0.9-1.6%, 0.6-1.9%, or about 1.2% Quinoa Powder; about 0.86-1.05%, 0.84-1.07%, 0.81-1.10%, or about 0.95% Yacon Root Powder; about 0.54-0.65%, 0.52-0.67%, 0.49-0.70%, or about 0.60% Inulin; about 0.64-0.78%, 0.62-0.80%, 0.59-0.83%, or about 0.71% Chlorella Powder; about 0.64-0.78%, 0.62-0.80%, 0.59-0.83%, or about 0.71% Spirulina; about 0.55-0.67%, 0.53-0.69%, 0.50-0.72%, or about 0.61% Acerola Berry Powder; about 0.46-0.56%, 0.44-0.58%, 0.41-0.61%, or about 0.51% Camu Camu Extract; about 0.46-0.56%, 0.44-0.58%, 0.41-0.61%, or about 0.51% Pomegranate Juice Powder; about 0.46-0.56%, 0.44-0.58%, 0.41-0.61%, or about 0.51% Sacha Inchi Powder; about 0.37-0.45%, 0.35-0.47%, 0.32-0.50%, or about 0.41% Astragalus Root Powder; about 0.37-0.45%, 0.35-0.47%, 0.32-0.50%, or about 0.41% Bilberry Fruit Powder; about 0.37-0.45%, 0.35-0.47%, 0.32-0.50%, or about 0.41% Blueberry Fruit Powder; about 0.37-0.45%, 0.35-0.47%, 0.32-0.50%, or about 0.41% Lycium/Goji Berry Powder; about 0.37-0.45%, 0.35-0.47%, 0.32-0.50%, or about 0.41% Spinach Powder; about 0.27-0.34%, 0.25-0.36%, 0.22-0.39%, or about 0.31% Acai Powder; about 0.27-0.34%, 0.25-0.36%, 0.22-0.39%, or about 0.31% Methylsulfonylmethane; about 0.40-0.48%, 0.38-0.50%, 0.35-0.53%, or about 0.44% Natural Sweeteners; about 0.18-0.22%, 0.16-0.24%, 0.13-0.27%, or about 0.20% Ashwagandha Root Powder; about 0.18-0.22%, 0.16-0.24%, 0.13-0.27%, or about 0.20% Cordyceps Powder; about 0.18-0.22%, 0.16-0.24%, 0.13-0.27%, or about 0.20% Enzyme Blend; about 0.18-0.22%, 0.16-0.24%, 0.13-0.27%, or about 0.20% Kale; about 0.18-0.22%, 0.16-0.24%, 0.13-0.27%, or about 0.20% Maitake Powder; about 0.18-0.22%, 0.16-0.24%, 0.13-0.27%, or about 0.20% Reshi Mushroom Powder; about 0.17-0.21%, 0.15-0.23%, 0.12-0.26%, or about 0.19% Amaranth Flour Powder; about 0.15-0.18%, 0.13-0.20%, 0.10-0.23%, or about 0.17% Salt, Himalayan Pink; about 0.14-0.17%, 0.12-0.19%, 0.09-0.22%, or about 0.15% Probiotic; about 0.092-0.112%, 0.090-0.114%, 0.087-0.117%, or about 0.102% Citrus Bioflavonoids; about 0.092-0.112%, 0.090-0.114%, 0.087-0.117%, or about 0.102% Grape Seed Extract; about 0.092-0.112%, 0.090-0.114%, 0.087-0.117%, or about 0.102% Green Tea Leaf Powder; about 0.092-0.112%, 0.090-0.114%, 0.087-0.117%, or about 0.102% Holy Basil Powder; about 0.092-0.112%, 0.090-0.114%, 0.087-0.117%, or about 0.102% Rose Hips Powder; about 0.092-0.112%, 0.090-0.114%, 0.087-0.117%, or about 0.102% Schisandra Berry Powder; about 0.090-0.110%, 0.088-0.112%, 0.085-0.115%, or about 0.100% Cinnamon Powder; about 0.046-0.056%, 0.044-0.058%, 0.041-0.061%, or about 0.051% Ginko Biloba Leaf Powder; about 0.046-0.056%, 0.044-0.058%, 0.041-0.061%, or about 0.051% Moringa Leaf Powder; and about 0.075-0.092%, 0.073-0.094%, 0.070-0.097%, or about 0.083% Mixed Tocopherols. In one embodiment, Formula I may consist of or may comprise or may consist essentially of all of these ingredients.

In accordance with the present invention, Formula I may also be provided in a vegan version (Formula I-vegan). In various embodiments, Formula I-vegan may consist of or may comprise or may consist essentially of one or more of: Pea Protein; Cocoa Powder; Agave Powder; Oat Protein; Rice Protein; Defatted Chia Powder; Yacon Root Powder; Maca Root Powder; Flaxseed; Xanthan Gum; Acerola Powder; Spirulina; Chlorella; Camu-Camu Powder; Pomegranate Powder; Astragalus Root Powder; Bilberry Fruit Powder; Blueberry Fruit Powder; Lycium/Goji Berry Powder; Salt, Himalayan Pink; Moringa Leaf Powder; Pea Fiber; Quinoa Powder; Acai Powder; Methylsulfonylmethane; Spinach Powder; Natural Sweeteners; Ashwagandha Root Powder; Cordyceps Powder; Enzyme Blend; Maitake Powder; Reshi Mushroom Powder; Probiotic; Kale Leaves Powder; Citrus Bioflavonoids; Green Tea Leaf Powder; Holy Basil Powder; Rose Hips Powder; Schisandra Berry Powder; Amaranth Powder; Cinnamon Powder; and Ginko Biloba Leaf Powder.

In various embodiments, Formula I-vegan may consist of or may comprise or may consist essentially of one or more of: about 23-28%, 21-30%, 18-33%, or about 26% Pea Protein; about 18-22%, 16-24%, 13-27%, or about 20% Cocoa Powder; about 15-18%, 13-20%, 10-23%, or about 16% Agave Powder; about 14-17%, 12-19%, 9-22%, or about 16% Oat Protein; about 2.4-3.0%, 2.2-3.2%, 1.9-3.5%, or about 2.7% Rice Protein; about 2.2-2.6%, 2.0-2.8%, 1.7-3.1%, or about 2.4% Defatted Chia Powder; about 2.1-2.6%, 1.9-2.8%, 1.6-3.1%, or about 2.3% Yacon Root Powder; about 2.1-2.6%, 1.9-2.8%, 1.6-3.1%, or about 2.3% Maca Root Powder; about 1.1-1.4%, 0.9-1.6%, 0.6-1.9%, or about 1.2% Flaxseed; about 0.69-0.84%, 0.67-0.86%, 0.64-0.89%, or about 0.77% Xanthan Gum; about 0.63-0.77%, 0.61-0.79%, 0.58-0.82%, or about 0.70% Acerola Powder; about 0.58-0.70%, 0.56-0.72%, 0.53-0.75%, or about 0.64% Spirulina; about 0.58-0.70%, 0.56-0.72%, 0.53-0.75%, or about 0.64% Chlorella; about 0.52-0.64%, 0.50-0.66%, 0.47-0.69%, or about 0.58% Camu-Camu Powder; about 0.52-0.64%, 0.50-0.66%, 0.47-0.69%, or about 0.58% Pomegranate Powder; about 0.42-0.51%, 0.40-0.53%, 0.37-0.56%, or about 0.47% Astragalus Root Powder; about 0.42-0.51%, 0.40-0.53%, 0.37-0.56%, or about 0.47% Bilberry Fruit Powder; about 0.42-0.51%, 0.40-0.53%, 0.37-0.56%, or about 0.47% Blueberry Fruit Powder; about 0.42-0.51%, 0.40-0.53%, 0.37-0.56%, or about 0.47% Lycium/Goji Berry Powder; about 0.42-0.51%, 0.40-0.53%, 0.37-0.56%, or about 0.47% Salt, Himalayan Pink; about 0.42-0.51%, 0.40-0.53%, 0.37-0.56%, or about 0.47% Moringa Leaf Powder; about 0.35-0.42%, 0.33-0.44%, 0.30-0.47%, or about 0.38% Pea Fiber; about 0.33-0.41%, 0.31-0.43%, 0.28-0.46%, or about 0.37% Quinoa Powder; about 0.31-0.38%, 0.29-0.40%, 0.26-0.43%, or about 0.35% Acai Powder; about 0.31-0.38%, 0.29-0.40%, 0.26-0.43%, or about 0.35% Methylsulfonylmethane; about 0.31-0.38%, 0.29-0.40%, 0.26-0.43%, or about 0.35% Spinach Powder; about 0.31-0.38%, 0.29-0.40%, 0.26-0.43%, or about 0.35% Natural Sweeteners; about 0.21-0.26%, 0.19-0.28%, 0.16-0.31%, or about 0.23% Ashwagandha Root Powder; about 0.21-0.26%, 0.19-0.28%, 0.16-0.31%, or about 0.23% Cordyceps Powder; about 0.21-0.26%, 0.19-0.28%, 0.16-0.31%, or about 0.23% Enzyme Blend; about 0.21-0.26%, 0.19-0.28%, 0.16-0.31%, or about 0.23% Maitake Powder; about 0.21-0.26%, 0.19-0.28%, 0.16-0.31%, or about 0.23% Reshi Mushroom Powder; about 0.16-0.19%, 0.14-0.21%, 0.11-0.24%, or about 0.17% Probiotic; about 0.10-0.13%, 0.08-0.15%, 0.05-0.18%, or about 0.12% Kale Leaves Powder; about 0.10-0.13%, 0.08-0.15%, 0.05-0.18%, or about 0.12% Citrus Bioflavonoids; about 0.10-0.13%, 0.08-0.15%, 0.05-0.18%, or about 0.12% Green Tea Leaf Powder; about 0.10-0.13%, 0.08-0.15%, 0.05-0.18%, or about 0.12% Holy Basil Powder; about 0.10-0.13%, 0.08-0.15%, 0.05-0.18%, or about 0.12% Rose Hips Powder; about 0.10-0.13%, 0.08-0.15%, 0.05-0.18%, or about 0.12% Schisandra Berry Powder; about 0.10-0.13%, 0.08-0.15%, 0.05-0.18%, or about 0.12% Amaranth Powder; about 0.10-0.13%, 0.08-0.15%, 0.05-0.18%, or about 0.11% Cinnamon Powder; and about 0.052-0.064%, 0.050-0.066%, 0.047-0.069%, or about 0.058% Ginko Biloba Leaf Powder. In one embodiment, Formula I-vegan may consist of or may comprise or may consist essentially of all of these ingredients.

In various embodiments, a subject consumes Formula I or I-vegan in the morning; for instance, at breakfast. In various embodiments, the subject consumes Formula I or I-vegan daily. As a non-limiting example, one serving of Formula I or I-vegan (for example, a packet of about 40, 42, 44, 46, 48 or 50 g Formula I powder) may be combined with about 8-12 fl. oz. water or other beverage (milk, almond milk, rice milk, juice, etc.) and ice in a blender; blended until creamy; and consumed by a subject. In one embodiment, Formula I or I-vegan is consumed by a subject within about 30 minutes after preparation.

In various embodiments, the present invention provides a composition (Formula II) for controlling body weight and/or for promoting weight loss. Ingredients of Formula II may include but are not limited to Oat protein, Pea protein, Agave (Agave tequilana, fruit), Maize (fiber), Vitamins and Minerals, MCT (medium chain triglycerides), Natural vanilla flavor (with other natural flavors), Xanthan gum, Bacillus Coagulans, Stevia (Stevia Rebaudiana, leaf), Potato protein extract, and Luo Han Guo (Monk fruit, Momordica grosvenori swingle).

In various embodiments, all the ingredients of Formula II are dry blended together. In various embodiments, one serving of Formula II is packaged as one packet.

Formula II is formulated to satisfy hunger cravings while providing nutrition for healthy weight loss. In one embodiment, each serving includes plant protein, which, while not wishing to be bound by any particular theory, is believed to maintain lean muscle while the body burns fat; and a potato protein extract (P12) that, while not wishing to be bound by any particular theory, is believed to stimulate the production of CCK (a natural appetite suppressant). Formula II has a source of fiber for digestive health; and medium chain triglycerides (MCTs) to maintain relatively high metabolism. Ingredients of Formula II may include but are not limited to: oat protein, pea protein, agave fruit powder, maize fiber, medium chain triglycerides, natural flavor, xanthan gum, potato protein extract, bacillus coagulans (probiotic), stevia leaf extract, monk fruit extract, and various vitamins.

In various embodiments, Formula II may consist of or may comprise or may consist essentially of one or more of: Oat Protein; Pea Protein; Agave Powder; Nutriose FM 06; Medium Chain Triglyceride oil; Vitamin/mineral premix; Natural Flavors; Xanthan gum; Probiotic; Natural Sweeteners; and Potato protein Extract.

In various embodiments, Formula II may consist of or may comprise or may consist essentially of one or more of: about 34-42%, 32-44%, 29-47%, or about 38% Oat Protein; about 26-32%, 24-34%, 21-37%, or about 29% Pea Protein; about 12-14%, 10-16%, 7-19%, or about 13% Agave Powder; about 70.1-80.7%, 60.9-80.9%, 60.6-90.2%, or about 7.9% Nutriose FM 06; about 3.8-4.6%, 3.6-4.8%, 3.3-5.1%, or about 4.2% Medium Chain Triglyceride oil; about 3.3-4.1%, 3.1-4.3%, 2.8-4.6%, or about 3.7% Vitamin/mineral premix; about 2.8-3.5%, 2.6-3.7%, 2.3-4.0%, or about 3.2% Natural Flavors; about 0.95-1.16%, 0.93-1.18%, 0.90-1.21%, or about 1.05% Xanthan gum; about 0.13-0.16%, 0.11-0.18%, 0.08-0.21%, or about 0.15% Probiotic; about 0.13-0.16%, 0.11-0.18%, 0.08-0.21%, or about 0.15% Natural Sweeteners; and about 0.057-0.070%, 0.055-0.072%, 0.052-0.075%, or about 0.063% Potato protein Extract. In one embodiment, Formula II may consist of or may comprise or may consist essentially of all of these ingredients.

In various embodiments, a subject consumes Formula II mid-day, for instance, at lunch. In various embodiments, a subject consumes Formula II later in the day, for instance, at dinner. In various embodiments, a subject consumes Formula II both at both times (i.e., at lunch and at dinner). In various embodiments, the subject consumes Formula II at least once daily. As a non-limiting example, one serving of Formula II (for example, a packet of 47.5 g Formula II powder) is combined with about 10 fl. oz. water or beverage (milk, almond milk, rice milk, juice, etc.) in a blender; blended until creamy; and consumed by a subject. In one embodiment, Formula II is consumed by a subject within about 30 minutes after preparation.

In various embodiments, the present invention provides a composition (Formula III) for controlling body weight and/or for promoting weight loss. Ingredients of Formula III may include but are not limited to Psyllium husk (Plantago ovata, seed), Flax (Linum usitatissimum, seed), Chia (Salvia hispanica, seed), Natural lemon flavor (with other natural flavors), Citric acid, and Stevia (Stevia Rebaudiana, leaf).

In various embodiments, all the ingredients of Formula III are dry blended together. In various embodiments, one serving of Formula III is packaged as one packet.

While not wishing to be bound by any particular theory, Formula III may gently eliminate waste from the digestive system and/or may support healthy intestinal flora.

In various embodiments, Formula III may consist of or may comprise or may consist essentially of one or more of: Psylium Husk; Flaxseed; Chia seed; Natural Flavors; Citric Acid; and Natural Sweeteners.

In various embodiments, Formula III may consist of or may comprise or may consist essentially of one or more of: about 40-49%, 38-51%, 35-54%, or about 45% Psylium Husk; about 32-39%, 30-41%, 27-44%, or about 36% Flaxseed; about 16-19%, 14-21%, 11-24%, or about 18% Chia seed; about 0.96-1.18%, 0.94-1.20%, 0.91-1.23%, or about 1.07% Natural Flavors; about 0.77-0.94%, 0.75-0.96%, 0.72-0.99%, or about 0.86% Citric Acid; and about 0.19-0.24%, 0.17-0.26%, 0.14-0.29%, or about 0.21% Natural Sweeteners. In one embodiment, Formula III may consist of or may comprise or may consist essentially of all of these ingredients.

In various embodiments, a subject consumes Formula III at mid-morning and/or mid-afternoon, for example, as a snack. In various embodiments, the subject consumes Formula III daily. As a non-limiting example, one serving of Formula III (for example, a packet of 14 g Formula III powder) is combined with about 8 fl. oz. distilled water; let sit for about one minute; mixed again; and consumed by a subject. In some situations, the drink will thicken. In one embodiment, Formula III is consumed by a subject within a few minutes after preparation.

The compositions disclosed herein may be formulated in form of a solid, liquid or emulsion. For example, the formulas are provided in solid form as packets of powder that may be added to water or a beverage of a subject's choice for ease of consumption. One packet may contain one serving (about 5-10, 10-20, 30-40, 40-50, 50-60, 60-70, 70-80, 80-90, 90-100 g) of a formula formulated in the amounts described herein. One packet of a formula may be mixed with about 6, 7, 8, 9, 10, 11 or 12 ounces of cold water. In various embodiments, the compositions according to the invention can be encapsulated, tableted or prepared in an emulsion or syrup for oral administration.

The compositions may be made following conventional techniques involving dry milling, mixing, and blending for powder forms; milling, mixing, granulation, and compressing for tablet forms; or milling, mixing and filling for hard gelatin capsule forms. The compositions of the invention may be sterilized by conventional sterilization techniques.

The compositions according to the invention may be delivered in an effective amount for controlling body weight and/or for promoting weight loss. The precise effective amount is that amount of the composition that will yield the most effective results in terms of efficacy of weight loss or maintenance in a given subject. This amount will vary depending upon a variety of factors, including but not limited to the characteristics of the formula's ingredients (including activity and bioavailability), the physiological condition of the subject (including age, sex, weight, metabolism, general physical condition, responsiveness to weight loss systems), and the route of administration. One ordinarily skilled in the art will be able to determine an effective amount through routine experimentation, for instance, by monitoring a subject's response to administration of a formula and adjusting the amounts of each accordingly.

The formulas may be administered in any number of routes. In accordance with the present invention, it is considered as “administering” that a subject consumes a composition as disclosed herein.

### Methods of the Invention

In various embodiments, the present invention provides a method for controlling body weight and/or for promoting weight loss in a subject. The method may consist of or may comprise or may consist essentially of: providing one or more compositions described herein and administering an effective amount of the one or more compositions to the subject, thereby controlling body weight and/or promoting weight loss in the subject. In various embodiments, the method may consist of or may comprise or may consist essentially of: providing any one or more of Formula I or I-vegan, Formula II, and Formula III; and administering an effective amount of the one or more of Formula I or I-vegan, Formula II, and Formula III to the subject, thereby controlling body weight and/or promoting weight loss in the subject.

In various embodiments, the method may consist of or may comprise or may consist essentially of: providing Formula I or I-vegan, Formula II, and Formula III; and administering an effective amount of Formula I or I-vegan, Formula II, and Formula III to the subject. In one embodiment, the method may consist of or may comprise or may consist essentially of: providing Formula I and/or I-vegan; and administering an effective amount of Formula I and/or I-vegan to the subject. In another embodiment, the method may consist of or may comprise or may consist essentially of: providing Formula II; and administering an effective amount of Formula II to the subject. In still another embodiment, the method may consist of or may comprise or may consist essentially of: providing Formula III; and administering an effective amount of Formula III to the subject. In some embodiments, the method may consist of or may comprise or may consist essentially of: providing Formula I or I-vegan, and Formula II; and administering an effective amount of the provided compositions to the subject. In some embodiments, the method may consist of or may comprise or may consist essentially of: providing Formula I or I-vegan, and Formula III; and administering an effective amount of the provided compositions to the subject. In some embodiments, the method may consist of or may comprise or may consist essentially of: providing Formula II and Formula III; and administering an effective amount of the provided compositions to the subject.

In various embodiments, the subject is normal, overweight, or obese. In various embodiments, the subject has a BMI between 18.5 and 25. In various embodiments, the subject has a BMI between 25 and 30. In various embodiments, the subject has a BMI above 30.

In various embodiments, the one or more of Formula I or I-vegan, Formula II, and Formula III is provided in powder. In various embodiments, the one or more of Formula I or I-vegan, Formula II, and Formula III is provided as one serving per packet.

In various embodiments, the one or more of Formula I or I-vegan, Formula II, and Formula III is administered at about 5-10, 10-20, 20-30, 30-40, 40-50, 50-60, 60-70, 70-80, 80-90 or 90-100 g per serving. In various embodiments, the one or more of Formula I or I-vegan, Formula II, and Formula III are each administered one, two, three, four or five times per day. In various embodiments, the one or more of Formula I or I-vegan, Formula II, and Formula III is administered for about 1-3, 3-10, 10-20, 20-30, 30-40, 40-50, 50-60, 60-70, 70-80, 80-90 or 90-100 days, 1-6 or 6-12 months, or 1-5 years.

In various embodiments, Formula I or I-vegan is administered at breakfast. In various embodiments, Formula I or I-vegan is administered with fruit. In various embodiments, Formula II is administered at lunch. In various embodiments, Formula II is administered with fruit, vegetable, hummus and/or avocado. In various embodiments, Formula II is administered at dinner. In various embodiments, Formula II is administered with a meal and/or vegetable broth.

In various embodiments, Formula III is administered mid-morning and/or mid-afternoon. In various embodiments, the one or more of Formula I or I-vegan, Formula II, and Formula III is administered to a subject with water or a beverage. In various embodiments, the one or more of Formula I or I-vegan, Formula II, and Formula III is administered to substitute a meal or snack.

In various embodiments, the one or more of Formula I or I-vegan, Formula II, and Formula III is administered orally to the subject.

### Kits of the Invention

In various embodiments, the present invention provides a kit for controlling body weight and/or for promoting weight loss in a subject. The kit may consist of or may comprise or may consist essentially of: any one or more of Formula I or I-vegan, Formula II, and Formula III; and instructions for using the one or more of Formula I or I-vegan, Formula II, and Formula III to control body weight and/or promote weight loss in the subject.

The kit is an assemblage of materials or components, including at least one of the inventive compositions. In one embodiment, the kit may consist of or may comprise or may consist essentially of Formula I and/or I-vegan. In another embodiment, the kit may consist of or may comprise or may consist essentially of Formula II. In still another embodiment, the kit may consist of or may comprise or may consist essentially of Formula III. In some embodiments, the kit may consist of or may comprise or may consist essentially of Formula I or I-vegan, and Formula II. In some embodiments, the kit may consist of or may comprise or may consist essentially of Formula I or I-vegan, and Formula III. In some embodiments, the kit may consist of or may comprise or may consist essentially of Formula II and Formula III. In other embodiments, the kit may consist of or may comprise or may consist essentially of Formula I or I-vegan, Formula II, and Formula III. Each of the aforesaid kits may contain one or more servings of each of Formula I or I-vegan, Formula II and/or Formula III.

Instructions for use may be included in the kit. “Instructions for use” typically include a tangible expression describing the technique to be employed in using the components of the kit to affect a desired outcome. In various embodiments, the instructions comprise a program guide, meal planner, manual, and/or recipe guide. Optionally, the kit also contains other useful components, such as, water, tea, beverages, fruits, vegetables, containers, applicators, measuring tools, or other useful materials as will be readily recognized by those of skill in the art.

The materials or components assembled in the kit can be provided to the practitioner stored in any convenient and suitable ways that preserve their operability and utility. The components are typically contained in suitable packaging material(s). As employed herein, the phrase “packaging material” refers to one or more physical structures used to house the contents of the kit, such as inventive compositions and the like. The packaging material is constructed by well-known methods, and may provide a sterile, contaminant-free environment. As used herein, the term “package” refers to a suitable solid matrix or material such as glass, plastic, paper, foil, and the like, capable of holding the individual kit components. Thus, for example, a package can be a paper packet to contain suitable quantities of a composition as described herein. The packaging material generally has an external label which indicates the contents and/or purpose of the kit and/or its components.

### EXAMPLES

The following examples are offered for illustrative purposes only, and are not intended to limit the scope of the present invention in any way.

### Example 1: Three Day Refresh

A daily diet includes a meal plan with four drinks per day. A 5-day study with 24 participants demonstrated a statistically significant three pound weight loss on average when using this meal plan. A second test with 20 participants finishing the study demonstrated a 2.8 pound weight loss. In addition, waist and hip measurements demonstrated a 1.6″ and 1.1″ loss, respectively, over three days.

The kit used in this instance includes a three-day regimen of Formula I for breakfast, Formula II for lunch (20 g) and dinner (to be consumed with a vegetable side dish), Formula III for mid-afternoon, and a program guide with meal planner for adding fruits and vegetables to the diet.

### Example 2: A Daily Meal Plan

In the morning, upon waking, a subject consumes about 8-10 fl. oz. filtered water. Within about 1 hour of waking up, the subject consumes Formula I as a breakfast. For example, the subject consumes one serving of Formula I that is blended in about 1¼ cups (10 fl. oz.) filtered water. Formula I may be blended with ice. Formula I may be blended with any of the flavorings listed in Table 1. In addition, the subject consumes an item from the fruit list (Table 2). The fruit may be fresh or frozen, and is preferably unsweetened. The fruit may be blended with Formula I for consumption, or consumed as whole.

TABLE 1
Flavorings

Ground cinnamon
Ground nutmeg
Ground cloves
Ground ginger
Fresh lemon or lime juice
Fresh grated lemon or lime peel
Pure flavor extracts (vanilla, peppermint)
Chili pepper flakes

TABLE 2
Fruit List

| | |
|---|---|
| Apples | ½ medium |
| Apricots | 3 small or ½ cup sliced |
| Banana | ½ medium |
| Blackberries | ⅔ cup |
| Blueberries | ⅔ cup |
| Cantaloupe | 1 cup diced |
| Cherries | ⅔ cup (pitted) |
| Grapefruit | ½ large |
| Orange | ½ large |
| Peaches | 1 medium or ¾ cup sliced |
| Pears | ½ medium |
| Plums | 2 small |
| Raspberries | ¾ cup |
| Strawberries | 12 medium |

In the mid-morning, approximately two hours after breakfast, the subject consumes Formula III. For example, the subject consumes one serving of Formula III that is mixed in about 1 cup (8 fl. oz.) filtered water. Formula III may be drunk promptly after mixing.

Approximately one hour after the mid-morning Formula III consumption, the subject has a tea break. For example, the subject consumes about 1 cup (8 fl. oz.) of unsweetened herbal, black, or green tea.

At noon, approximately one hour after the tea break, the subject consumes Formula II as a lunch. For example, the subject consumes one serving of Formula II that is blended in about 1¼ cups (10 fl. oz.) filtered water. Formula II may be blended with ice. Formula II may be blended with any of the flavorings shown in Table 1. In addition, the subject consumes an item from the fruit list (Table 2). The fruit may be fresh or frozen, and is preferably unsweetened. The fruit may be blended with Formula II for consumption, or consumed as whole. Also, the subject consumes an item from the vegetable list (Table 3). The vegetables may be steamed before consuming. Vegetables can also be enhanced with any of the flavorings (Table 1). Additionally, the subject consumes 2 tablespoons of hummus or mashed avocado seasoned with lemon juice.

TABLE 3
Vegetable List

| | |
|---|---|
| Beets | 1 cup sliced |
| Carrots | ½ large |
| Celery | 2 medium stalks |
| Collard greens | ¼ cup chopped |
| Eggplant | ¾ cup cubed |
| Green beans | 12 beans |
| Jicama | ⅓ cup sliced |
| Kale | ½ cup chopped |
| Okra | 4 pods |
| Peppers (red) | 1 small |
| Snow peas | 10 pods |
| Spinach | 2 cups |
| Summer squash | 1 small |
| Swiss chard | 2 cups chopped |
| Tomato | 1 medium |
| Artichokes | ½ small |
| Asparagus | 5 medium spears |
| Broccoli | ¾ cup florets |
| Brussels sprouts | 2 medium |
| Cabbage | ¾ cup shredded |
| Cauliflower | ¾ cup florets |
| Mushrooms | 1 cup sliced |

In the mid-afternoon, approximately two hours after lunch, the subject consumes a snack. For example, the subject consumes an item from the vegetable list (Table 3) and 2 Tbsp. hummus or mashed avocado seasoned with lemon juice. As another example, the subject consumes an item from the juice list (Table 4).

TABLE 4
Juice List

Juice A (Makes 1 serving)
¼ cup raw green apple juice
¼ cup raw carrot juice
¼ cup raw celery juice
½ tsp. raw ginger juice
Juice B (Makes 1 serving)
½ cup raw kale juice
¼ cup raw orange juice
½ tsp. raw ginger juice
Juice C (Makes 1 serving)
¼ cup raw green apple juice
¼ cup raw beet juice
¼ cup raw celery juice
½ tsp. raw ginger juice

In the late afternoon, approximately 2 hours after the mid-afternoon snack, the subject optionally consumes about 1 cup (8 fl. oz.) unsweetened herbal tea. The herbal tea may be caffeine-free.

In the evening, approximately 2 hours after the snack, the subject consumes Formula II as a dinner. For example, the subject consumes one serving of Formula II that is blended in about 1¼ cups (10 fl. oz.) of water. Formula II may be blended with ice. Formula II may be blended with any of the flavorings (Table 1). The subject does not consume fruit at the dinner. In addition, the subject consumes one item from the dinner recipes list (Table 5). Also, the subject optionally consumes about 1 cup organic vegetable broth. About ¼ cup chopped fresh herbs (such as cilantro, parsley, tarragon, and basil) may be added to the broth.

TABLE 5
Dinner Recipes

Recipe A (Makes 1 serving)
½ cup water
½ cup chopped fresh broccoli or green beans
½ cup sliced fresh carrot
½ cup chopped fresh cauliflower
½ tsp. coconut oil (or olive oil if coconut oil is not available)
¼ tsp. sea salt

| | |
|---|---|
| 1. | Add water to medium saucepan; bring to a boil. |
| 2. | Add broccoli, carrots, and cauliflower to saucepan; cover and cook 4 to 5 minutes or |
| | until crisp-tender. |
| 3. | To serve, place vegetables in serving bowl. Add coconut oil and salt; toss gently to |
| | coat. |

Recipe B (Makes 1 serving)
8 medium asparagus spears, ends trimmed
1 tsp. olive oil
1 pinch sea salt
1 tsp. slivered almonds

| | |
|---|---|
| 1. | Preheat oven to 400° F. |
| 2. | Arrange asparagus in a single layer on a baking sheet. Drizzle with oil and sprinkle |
| | with salt. |
| 3. | Bake for 25 minutes, or until tender-crisp. Remove from oven. |
| 4. | Sprinkle with almonds; serve. |

Recipe C (Makes 1 serving)
6 oz. green beans, ends trimmed
1 cup water
½ tsp. olive oil
1 tsp. fresh lemon juice
¼ tsp. finely grated lemon peel
Sea salt (to taste; optional)

| | |
|---|---|
| 1. | Place green beans and water in medium saucepan over high heat. Bring to a boil. |
| | Reduce heat to maintain a gentle boil; cook, covered, for 3 to 4 minutes, or until |
| | tender-crisp. Remove from heat. Drain. |
| 2. | Combine green beans, oil, lemon juice, and lemon peel in small bowl; mix well. |
| | Sprinkle with salt (if desired). |

Recipe D (Makes 1 serving)
½ tsp. olive oil
½ clove garlic
½ tsp. grated fresh ginger
½ cup green beans
½ cup sliced fresh carrot
½ cup sliced fresh red bell pepper
¼ tsp. sea salt
2 Tbsp. organic vegetable broth

| | |
|---|---|
| 1. | Heat oil in medium skillet over medium heat; add garlic and ginger. |
| 2. | Cook, stirring frequently, for 1 to 2 minutes or until fragrant. |
| 3. | Add green beans, carrot, pepper, salt and broth. |
| 4. | Cook for 5 to 7 minutes, or until vegetables are tender-crisp. |

Recipe E (Makes 1 serving)
2 cups baby spinach or salad greens
½ medium cucumber, chopped
½ medium red bell pepper, sliced
¼ cup sprouts (e.g., radish, alfalfa, or broccoli)
½ medium tomato, chopped
½ tsp. extra-virgin olive oil
1 Tbsp. fresh lemon juice
1 tsp. raw pumpkin or sunflower seeds

| | |
|---|---|
| 1. | Combine greens, cucumber, bell pepper, sprouts, tomato, olive oil, and lemon juice in |
| | a large bowl; toss gently to blend. Top with seeds. |

In the evening, approximately 2 hours after dinner, the subject optionally takes an herbal tea break. For example, the subject may consume about 1 cup (8 fl. oz.) unsweetened herbal tea. The herbal tea may be caffeine-free.

Throughout the day, in addition to the water consumed in above formulas and teas, the subject consumes at least about 8 cups (64 fl. oz.) filtered water.

The various methods and techniques described above provide a number of ways to carry out the application. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

Preferred embodiments of this application are described herein, including the best mode known to the inventors for carrying out the application. Variations on those preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

It is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

The foregoing description of various embodiments of the invention known to the applicant at this time of filing the application has been presented and is intended for the purposes of illustration and description. The present description is not intended to be exhaustive nor limit the invention to the precise form disclosed and many modifications and variations are possible in the light of the above teachings. The embodiments described serve to explain the principles of the invention and its practical application and to enable others skilled in the art to utilize the invention in various embodiments and with various modifications as are suited to the particular use contemplated. Therefore, it is intended that the invention not be limited to the particular embodiments disclosed for carrying out the invention.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention.

1-8. (canceled)

9. A method for controlling body weight and/or for promoting weight loss in a subject, comprising:
providing one or more of each of Formula I or I-vegan, Formula II, and Formula III; and
administering an effective amount of the one or more of each of Formula I or I-vegan, Formula II, and Formula III to the subject, thereby controlling body weight and/or promoting weight loss in the subject.

10. The method claim 9, wherein the subject is a human.

11. The method claim 9, wherein the subject is normal, overweight, or obese.

12. The method claim 9, wherein the subject has a BMI between 18.5 and 25.

13. The method claim 9, wherein the subject has a BMI between 25 and 30.

14. The method claim 9, wherein the subject has a BMI above 30.

15. The method claim 9, wherein the one or more of each of Formula I or I-vegan, Formula II, and Formula III is provided in powder form.

16. The method claim 9, wherein the one or more of each of Formula I or I-vegan, Formula II, and Formula III is provided as one serving per packet.

17. The method claim 9, wherein the one or more of each of Formula I or I-vegan, Formula II, and Formula III is administered at about 5-10, 10-20, 20-30, 30-40, 40-50, 50-60, 60-70, 70-80, 80-90 or 90-100 g per serving.

18. The method claim 9, wherein the one or more of each of Formula I or I-vegan, Formula II, and Formula III is each independently administered one, two, three, four or five times per day.

19. The method claim 9, wherein the one or more of each of Formula I or I-vegan, Formula II, and Formula III is administered repeatedly for about 1-3, 3-10, 10-20, 20-30, 30-40, 40-50, 50-60, 60-70, 70-80, 80-90 or 90-100 days, 1-6 or 6-12 months, or 1-5 years.

20. The method claim 9, wherein Formula I or I-vegan is administered at breakfast.

21. The method claim 9, wherein Formula I or I-vegan is administered with a fruit.

22. The method claim 9, wherein Formula II is administered at lunch.

23. The method claim 9, wherein Formula II is administered with a fruit, vegetable, hummus and/or avocado.

24. The method claim 9, wherein Formula II is administered at dinner.

25. The method claim 9, wherein Formula III is administered mid-morning and/or mid-afternoon.

26. The method claim 9, wherein the one or more of each of Formula I or I-vegan, Formula II, and Formula III is administered orally to the subject.

27. The method claim 9, wherein the one or more of each of Formula I or I-vegan, Formula II, and Formula III is administered with water or a beverage to the subject.

28-29. (canceled)
